(19) United States
(12) Patent Application Publication
(10) Pub. No.: US 2018/0199716 A1
(43) Pub. Date: Jul. 19, 2018

(54) SMART CHAIR

(71) Applicant: PALM BEACH TECHNOLOGY LLC, WEST PALM BEACH, FL (US)

(72) Inventors: DIEGO BERTINATO, TAUFKIRCHEN/VILS (DE); ELIO RAVAIOLI, TAUFKIRCHEN/VILS (DE)

(73) Assignee: PALM BEACH TECHNOLOGY LLC, WEST PALM BEACH, FL (US)

(21) Appl. No.: 15/405,330

(22) Filed: Jan. 13, 2017

(51) Int. Cl. A47C 1/024; G08C 17/02; H04W 4/00; G10L 15/22; G06F 3/01; A47C 7/72; A47C 31/00

(52) U.S. Cl. CPC A47C 1/0242; G08C 17/02; H04W 4/008; H04W 84/12; G06F 3/017; A47C 7/72; A47C 31/008; G10L 15/22

(57) ABSTRACT

A seating/reclining furniture includes at least one component selected from a seat part, a back part, a headrest, a footrest, and an armrest, an actuator which manipulates the at least one component, and a control device which controls the actuator. The control device includes a command recognition module and a command conversion module. The command recognition module checks at least one command pattern initiated by a user for a correspondence with at least one predefined command pattern which is representative of an actuation mode of the actuator. The command conversion module converts the command pattern into a control command for controlling the actuator based on the correspondence of the at least one command pattern to the at least one predefined command pattern.

### FIELD

The present invention relates to seating/reclining furniture, such as an armchair or a suite having a plurality of seating units, which has intelligent control functions and which can therefore also be called a “smart chair”.

### BACKGROUND

Armchairs have previously been described which are, for example, colloquially also called TV chairs, and that comprise components which can be manipulated by actuators. Such chairs can, for example, in particular comprise components that can be manipulated by an actuator in the form of a seat part that can be adjusted by an actuator, a back part that can be adjusted by an actuator, a headrest that can be adjusted by an actuator, a footrest that can be adjusted by an actuator or, for example, an armrest that can be adjusted by an actuator to name but a few exemplary components of such chairs that can be manipulated. Such chairs can also, for example, have a massage function. Such a chair can therefore have a component that can be manipulated by an actuator, for example, a back part or a seat part, into which the corresponding massage actuators are integrated via which the respective component can be moved and/or deformed and thus manipulated for massage purposes.

The actuators of such chairs are typically controlled by a wired remote control with discrete buttons via whose actuation a defined operating mode or actuation mode of the respective actuator can be controlled and/or activated. Such a remote control typically has one button, for example, whose actuation pivots the back part of the chair to the rear and another button whose actuation pivots the rear part to the front. Corresponding buttons can also be provided for the different operating modes or actuation modes of the actuators for the headrest, for the seat part, for the footrest, for the armrests and/or for the massage actuators.

The operating comfort of chairs operable via a wired remote control is admittedly better compared to a chair in which the individual components must be actuated manually or purely mechanically. A need nonetheless exists to improve operating comfort since the user of the chair must always access the remote control to activate individual functions, which can be difficult in a reclining position of the seating/reclining furniture if the remote control cannot be reached or if it can only be reached with difficulty from the reclining position. The user must furthermore rise from the chair if he/she wants to actuate devices in the environment of the chair, such as an air-conditioning unit, an entertainment unit, or, for example, an electric blind, if no remote control is present therefor and even if there is, such a remote control may not be reachable or may only be reachable, for example, with difficulty from the reclining position.

### SUMMARY

An aspect of the present invention to provide seating/reclining furniture that offers the user comfort that is as great as possible.

In an embodiment, the present invention provides a seating/reclining furniture which includes at least one component selected from a seat part, a back part, a headrest, a footrest, and an armrest, at least one actuator which is configured to manipulate one of the at least one component, and a control device which is configured to control the at least one actuator. The control device comprises a command recognition module and a command conversion module. The command recognition module is configured to check at least one command pattern initiated by a user for a correspondence with at least one predefined command pattern which is representative of an actuation mode of the at least one actuator. The command conversion module is configured to convert the command pattern into a control command for controlling the at least one actuator based on the correspondence of the at least one command pattern to the at least one predefined command pattern.

### BRIEF DESCRIPTION OF THE DRAWINGS

The present invention is described in greater detail below on the basis of embodiments and of the drawings in which:

FIG. 1 shows a living room situation with seating/reclining furniture in accordance with the present invention;

FIG. 2 shows different modules of the seating/reclining furniture in accordance with the present invention; and

FIG. 3 shows an exemplary control device of a seating/reclining furniture in accordance with the present invention.

### DETAILED DESCRIPTION

In an embodiment, the present invention provides furniture which has a control unit for controlling the at least one actuator, wherein the control unit comprises a command recognition module and a command conversion module, with the command recognition module being adapted to check different command patterns initiated by a user for equivalences with predefined command patterns of which each one is representative of one actuation mode of the at least one actuator, and with the command conversion module being adapted to convert the command pattern into a control command for controlling the at least one actuator on a correspondence of a command pattern that was recognized by the command recognition module.

The control of the individual functions or of the respective actuators of the piece of furniture therefore does not take place in a known manner via a wired remote control by actuating discrete buttons; the present invention much rather provides that the seating/reclining furniture has a function via which the individual functions or actuators of the piece of furniture can be accessed by command patterns initiated by a user.

The command recognition module has a function via which the command patterns initiated by a user can be checked for correspondences with predefined command patterns of which each one is representative of an actuation mode of the at least one actuator. A predefined command pattern exists, for example, that is representative of the function “headrest back”, and another command pattern exists that is representative of the function “headrest forward”. If the user, for example, intends to access the function “headrest back”, the user must merely initiate the corresponding command pattern for this purpose. If the command pattern initiated by the user in this respect corresponds to the predefined command pattern for the function “headrest back”, this correspondence is recognized by the command recognition module, whereupon the command conversion module can convert the command pattern into a corresponding control command by which the actuator is controlled to adjust the headrest to adjust the headrest to the rear. If, in contrast, the command pattern initiated by the user does not correspond to the predefined command pattern for the function “headrest back”, the command conversion module does not convert the command pattern initiated by the user into a control command to control the headrest actuator.

As becomes clear from the preceding explanations, only knowledge of the predefined command patterns is required to control the individual functions of the seating/reclining furniture. Since the number of actuators to be activated is, however, manageable, the learning effort to learn the predefined command patterns is small. In an embodiment, the command recognition feature can, for example, have a function that makes it possible to teach the command recognition module predefined command patterns of which each one is representative of an actuation mode of the at least one actuator. The user of the piece of furniture can thus think up specific predefined command patterns so that he/she does not have to adapt to or get used to specific command patterns.

In an embodiment, the command recognition module can, for example, also have a “teach function” that enables the command recognition module to recognize user-dependent mannerisms when initiating command patterns. The command recognition module can thus recognize specific deviations from predefined command patterns so that correspondences with predefined command patterns can be recognized even when command patterns initiated by the user have a certain deviation from the predefined command patterns.

In an embodiment, the present invention provides seating/reclining furniture which comprises a communication unit that can, for example, enable wireless communication with the internet, wherein the communication unit is adapted to transmit the control command for controlling an infrastructure device to the infrastructure device.

Unlike conventional chairs, the seating/reclining furniture in accordance with the present invention therefore does not only have an input unit by which the chair itself or its functions can be controlled. The present invention much rather provides that the seating/reclining furniture has an output unit or communication unit, for example, a WLAN adapter, via which infrastructure devices that are located in the environment of the seating/reclining furniture or at a remote site can be controlled using the input unit of the seating/reclining furniture.

Smart home appliances such as blinds, lamps or air-conditioning units can, for example, in particular be controlled via the communication unit of the piece of furniture using the input unit. Other devices in the environment of the seating/reclining furniture, such as audio and/or video units (TV, radio, hi-fi, etc. . . . ), can, however, also be controlled via the communication unit in accordance with the present invention.

The present invention thus makes use of the input unit of seating/reclining furniture anyway already present in that said input unit is expanded by functions for controlling devices, in particular in the environment of the piece of furniture. The seating/reclining furniture in accordance with the present invention thus serves to a certain extent as a control center, in particular for infrastructure devices located in the environment of the piece of furniture, so that the user of the piece of furniture can operate these devices via the seating/reclining furniture as a central control unit. The piece of furniture thereby offers the user the greatest possible comfort.

In an embodiment, the present invention provides seating/reclining furniture that combines the above embodiments.

Embodiments of the seating/reclining furniture in accordance with the present invention will now be explained.

In an embodiment, the present invention provides that the different command patterns initiated by a user can, for example, comprise voice commands, gesture commands and/or tactile command sequences. Based on the above example of the headrest adjustment, the user can therefore, for example, initiate or speak the voice command “headrest back” as the command pattern to adjust the headrest to the rear. The command recognition module thereupon checks the voice command “headrest back” initiated by the user against a previously stored command pattern “headrest back”. If a correspondence is determined to exist therefor, the command conversion module converts the command pattern “headrest back” into a control command to control the headrest actuator. The user can thus communicate wirelessly with the piece of furniture in that he/she initiates or speaks voice commands to control the components that can be manipulated.

In a corresponding manner, a gesture control can take place using gesture commands as the command patterns by the command recognition module checking gestures initiated by a user for correspondences with predefined gestures each of which is representative of an actuation mode of an actuator. If a correspondence with a predefined gesture is recognized, the command conversion module subsequently converts the gesture into a control command to control an actuator.

In contrast thereto, the control by initiating tactile command sequences takes place, for example, by the user initiating Morse-code like button sequences. A tactile command sequence can, for example, comprise the predefined command pattern “short, long, short”, with this tactile command sequence, for example, being representative of the actuation mode “headrest back”. Unlike the actuation of conventional wired remote controls in which the actuation of the corresponding buttons directly triggers a control command to control the respective actuator, and thus no command pattern recognition being required, the present invention here first compares the tactile command sequences with predefined command sequences to decide whether an actuator, and optionally which actuator, is to be controlled and which actuation mode of the respective actuator is to be initiated.

In an embodiment of the present invention, at least one microphone can, for example, be provided to detect voice commands initiated by a user. Such a microphone can, for example, be integrated into the seating/reclining furniture and in particular into a component thereof that can be manipulated by an actuator, for example, into a back part, into a headrest, or into an armrest of the piece of furniture. Additionally or alternatively thereto, a microphone to detect voice commands can also, however, be provided in a separate operating unit, such as in a smartphone that communicates wirelessly, in particular via Bluetooth, with the control device.

If the microphone is a component of the piece of furniture and is, for example, integrated into a headrest, the user of the piece of furniture can therefore, for example, simply speak the voice command “headrest back”, whereupon the headrest is retracted if the predefined voice pattern was recognized. The headrest can be controlled by voice commands in a corresponding manner, for example, via a smartphone, in that the smartphone, and in particular its microphone, is used to detect voice commands.

In an embodiment of the present invention, which can be considered as a supplement or as an alternative, the seating/reclining furniture can, for example, comprise a camera that can, for example, be integrated into a back part or into a headrest of the seating/reclining furniture to detect gesture commands initiated by a user. In addition or alternatively thereto, a touch unit, such as a touch pad or a touch screen, can be provided to input gestures which is integrated into the seating/reclining furniture or which can be a component of a separate operating unit, for example, of a smartphone, that communicates wirelessly, in particular via Bluetooth or infrared, with the control device. A touch pad can, for example, be integrated into an armrest of the seating/reclining furniture and in particular into its upholstery or covering so that a user on the piece of furniture can comfortably make gesture inputs into the touch pad.

In an embodiment of the present invention that can be considered as a supplement or as an alternative, the seating/reclining furniture can, for example, comprise at least one pressure-sensitive sensor that can, for example, be integrated into the seat part, the back part and/or the headrest of the piece of furniture to detect tactile command sequences initiated by a user. A pressure-sensitive sensor that is adapted to detect tactile command sequences initiated by a user can therefore be integrated into the headrest, for example, to adjust the headset. If a user therefore, for example, intends to adjust the headrest to the rear, he/she can, for example, initiate the command sequence “short, long, short” in accordance with a Morse code, for example, in that he/she exerts by the back of his/her head a short pressure pulse followed by a long-lasting pressure pulse that is in turn followed by a short pressure pulse onto the headrest or onto the pressure-sensitive sensor located therein.

The control of the respective actuators can advantageously takes place via tactile command sequences and not, for example, by individual tactile commands, since individual tactile commands such as a single pressure pulse could accidentally be initiated by the user, which would have the consequence of manipulating the seating furniture or its components even though the user had not actually intended such a manipulation.

To prevent an unintentional manipulation of the seating/reclining furniture, a further embodiment of the present invention provides that the command recognition module can, for example, be adapted to compare a predefined start command with a start command initiated by a user that is input via at least one of the command pattern recognition units from the group comprising microphone, camera, touch unit, and pressure-sensitive sensor. The command pattern conversion by the command conversion module is thereby only activated when the start command initiated by the user corresponds to the predefined start command. The predefined start command can, for example, be the voice pattern “Hi Molla” since “Hi” can be considered as a salutation and “Molla” can be considered as the name of the piece of furniture by which the latter is addressed. A specific gesture can, however, also be used as the start command.

In an embodiment of the present invention, the seating/reclining furniture can furthermore comprise a rechargeable battery to supply the individual electrical consumers of the seating/reclining furniture, such as the at least one actuator or the control device, with electrical energy.

In an embodiment of the present invention, a loudspeaker and/or a display device can, for example, be provided via which the seating/reclining furniture or its control device can communicate with the user. If a command pattern initiated by the user was not, for example, recognized by the command recognition module, the piece of furniture can advise the user thereof acoustically and/or visually via the loudspeaker and/or via the display device, and can prompt the user to again initiate the command pattern.

In an embodiment of the present invention, provision can, for example, be made that one or more components, in particular the footrest, has a safety device, for example, in the form of a pressure-sensitive sensor, that is in particular formed, for example, as a rail or as a plate, and that is integrated into the respective component. Such a sensor can respond, for example, when a resistance that acts against the adjustment movement is noticed on the adjustment of the component. If the inwardly folding footrest traps or threatens to trap an object, for example, a pet, or a body part of the user, this danger situation can be transmitted to the control device which thereupon stops the movement and to this extent interrupts the control of the actuators initiated by the command pattern. A higher priority is thus associated with the safety device than the control of the actuators initiated by the command pattern.

In an embodiment of the present invention, the input unit via which infrastructure devices in the environment of the seating/reclining furniture can also be controlled can, for example, comprise a control device which have a command recognition module and a command conversion module, with the commands to be input into the input unit in this case being command patterns initiated by a user as were previously described. The command recognition module can in this case be adapted to check different command patterns initiated by a user for correspondences with predefined command patterns, of which each one represents an actuation mode of an infrastructure device. The command conversion module can accordingly be adapted to convert a command pattern into a control command to control the infrastructure device on a correspondence of the command pattern.

If a user of the piece of furniture therefore intends to activate an air-conditioning unit, for example, he/she can, for example, initiate or speak the voice command pattern “air conditioning on”, whereupon the command recognition module compares this voice pattern with predefined voice patterns. If the command recognition module determines a correspondence to exist with the predefined command pattern “air conditioning on”, the command conversion module converts the command pattern into a corresponding control command to activate the air conditioning unit. Other infrastructure devices, such as TVs, radios, blinds, or lamps, to name but a few exemplary infrastructure devices, can be controlled in a corresponding manner via the seating/reclining furniture and in particular by its specially adapted input unit by voice, by gesture, and/or by tactile command sequences.

In an embodiment of the present invention, the seating/reclining furniture can, for example, comprise a diagnostic module that is adapted to carry out a functional diagnosis of the seating/reclining furniture. If the free adjustability of a component of the piece of furniture is, for example, blocked by an object, this can be determined by the functional diagnosis and a measure can be suggested to the user that takes account of the functional diagnosis.

In an embodiment of the present invention, the diagnostic module can, for example, be adapted to start the functional diagnosis by itself and/or based on a command issued by a user. The functional diagnosis can, for example, be started after the end of predetermined time intervals or after a specific number of movement cycles of the actuators. If the user of the piece of furniture determines that some function of the piece of furniture is not working properly, he/she can in turn also actively start the functional diagnosis to have a possible remedy proposed to him/her.

In an embodiment of the present invention, the command recognition module can, for example, be adapted to check a command pattern initiated by a user for correspondences with a predefined command pattern representative of the start of the functional diagnosis, with the command conversion module being adapted to convert the command pattern into a start command for starting the functional diagnosis on a correspondence of said command pattern. The user can, for example, initiate or speak the command pattern “functional diagnosis” if he/she determines that any function of the piece of furniture is not working properly. If the command pattern “functional diagnosis” initiated by the user is recognized by the command recognition module, a corresponding start command to start the functional diagnosis is thereupon generated by the command conversion module.

In an embodiment of the present invention, the diagnostic module can, for example, be adapted to determine a measure that takes account of the diagnosis result of the functional diagnosis and/or to transmit the diagnosis result of the functional diagnosis to a remote entity via the communication unit. The remote entity can, for example, be a service center of the manufacturer of the piece of furniture that can in turn determine a remedy based on the diagnosis result on receipt of the functional diagnosis, with the remedy determined by the remote entity then being receivable by the communication unit.

The seating/reclining furniture can thus not only communicate with infrastructure devices in the direct environment via the communication unit, but also, for example, with remote entities over the internet so that a remote diagnosis of the piece of furniture via the communication unit also becomes possible as required. If such a remote diagnosis determines, for example, that a repair or a replacement of a part of the piece of furniture is required, the service center can, for example, arrange an appointment with a service engineer to repair the piece of furniture or can ship a replacement part.

The seating/reclining furniture in accordance with the present invention will now be described below based on an example under reference to the drawings.

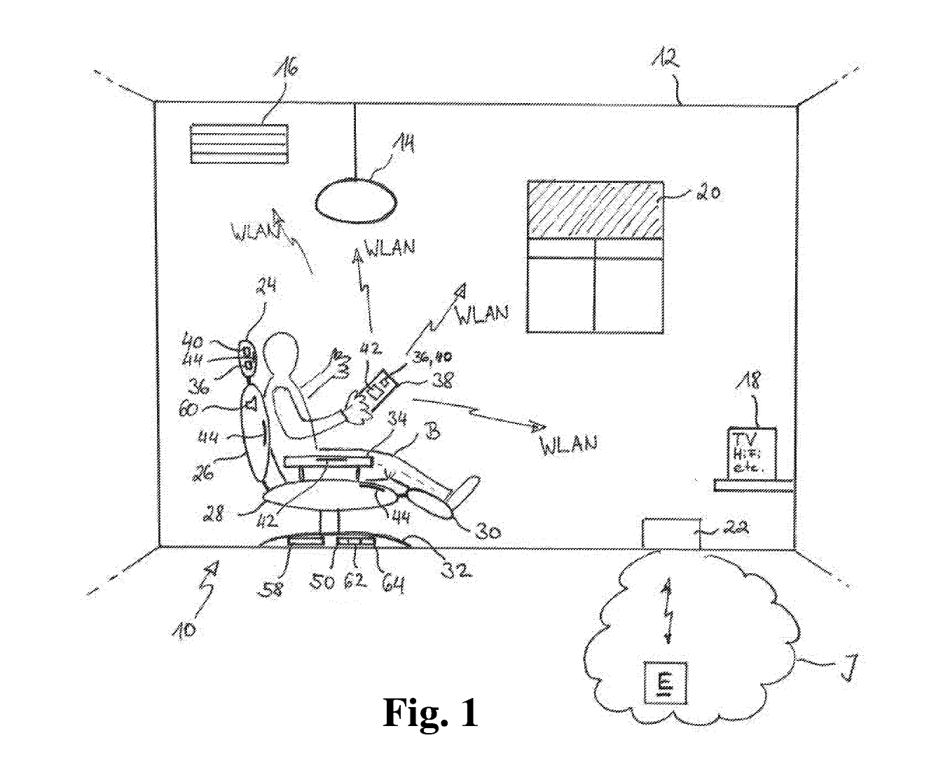

FIG. 1 shows a living room situation with seating/reclining furniture 10 in accordance with the present invention in a living room 12. The living room 12 is equipped with different infrastructure devices such as a lamp 14, an air-conditioning unit 16, an entertainment unit 18 (TV, radio, hi-fi, etc.) and an electric blind 20. A router 22 is furthermore present via which a connection to the internet I can be established to allow communication and data exchange with remote entities E.

The seating/reclining furniture 10, which is also hereinafter only called a piece of furniture 10, has a base 32 with which the piece of furniture 10 stands on the floor of the living room 12. A seat part 28 to which a back part 26 serving as a backrest and a footrest 30 are connected in an articulated manner is fastened to the base 32. A headrest 24 is in turn connected in an articulated manner to the back part 26. The piece of furniture 10 also has armrests 34 that can, for example, be fastened to the seat part 28. The position of the seat part 28 is variable with respect to the base 32, the position of the back part 26 is variable with respect to the seat part 28, the position of the footrest 30 is variable with respect to the seat part 28, and the position of the headrest 24 is variable with respect to the back part 26. The position of the armrests 34 can also be varied with respect to the seat part 28.

To be able to adjust the position of components 24, 26, 28, 30, 34, corresponding actuators such as servo motors and/or piston-in-cylinder units are provided that are, however, not shown in FIG. 1 for reasons of clarity. The piece of furniture 10 can, for example, have actuators integrated into the back part 26 whose actuation can manipulate the back part 26 for massage purposes.

Such actuators are typically controlled by a wired remote control, for which purpose the remote control has a plurality of buttons to control the respective actuators. However, the present invention provides controlling the actuators by command patterns that are initiated by a user B who is seated on the piece of furniture 10 in the living room situation shown. Such command patterns can, for example, be voice commands, gesture commands, and/or tactile command sequences that the user B initiates.

To detect voice commands that are initiated by the user B, the piece of furniture 10 has a microphone 36 which is integrated into the headrest 24 in the shown embodiment. The microphone 36 can, however, also be integrated into the armrest 34, or be a separate operating unit 38, such as a smartphone, which the embodiment shows the user B holding in his hand and which communicates with the control device 50 of the piece of furniture 10 via Bluetooth, which will reviewed in greater detail below.

In the shown embodiment, the piece of furniture 10 furthermore has a camera 40 that is integrated into the headrest 24. The piece of furniture 10 is able via camera 40 to detect gesture commands initiated by user B, for example, with his/her hands, to control the individual actuators in that he/she performs a specific movement pattern in the air, for example, with his/her right hand that is recognized by the camera 40. Provision is furthermore made for the detection of gesture commands in the shown embodiment; the smartphone 38 has a touch unit 42 in the form of a touch screen or a touch pad via which gesture commands in the form of swiping gestures can be detected to control the individual actuators. A corresponding touch unit 42 is furthermore integrated into one of the armrests 34 via which the user B can also input corresponding swiping gesture commands.

The shown embodiment also shows the piece of furniture 10 to have pressure-sensitive sensors 44 that are integrated into the headrest 24, into the back part 26, and into the seat part 28. Morse-code like button sequences initiated by the user B for controlling the individual actuators can be detected via these pressure-sensitive sensors 44. The user B can, for example, initiate a short-long-short button sequence to adjust the headrest 24 to the rear in that he/she briefly presses the back of his/her head in a corresponding manner against the pressure-sensitive sensor 44 in the headrest 24, first short, then long, and then short again. A pressure-sensitive sensor 44 can, for example, alternatively or additionally be integrated into the seat part 28 or into the footrest 30 against which the user B presses one of his/her thighs or lower legs to give a command.

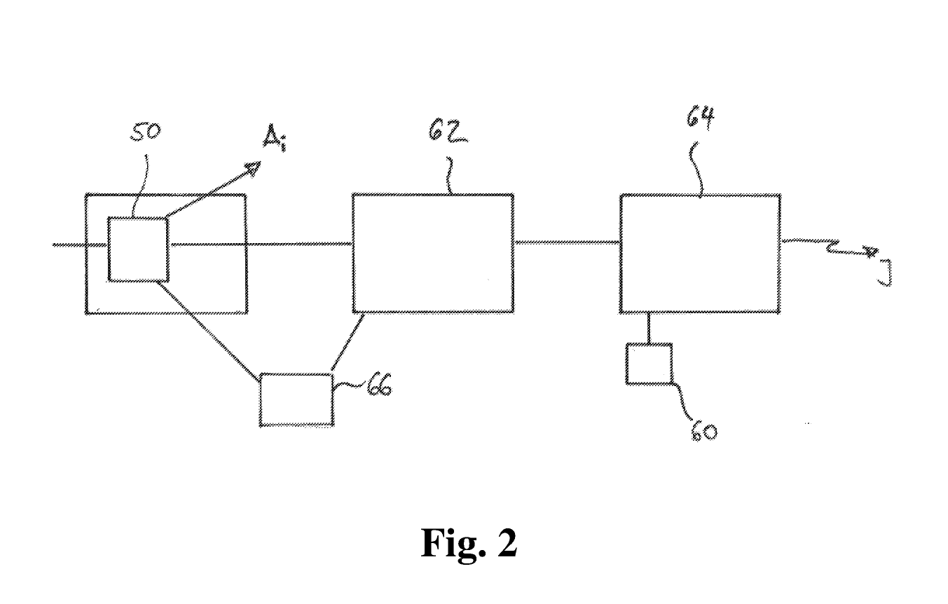

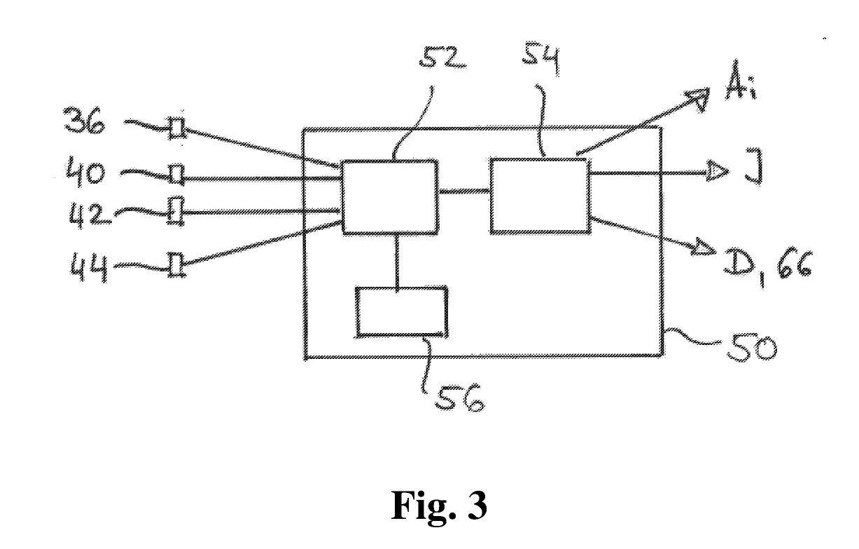

The command patterns detected by the command pattern detection units 36, 40, 42, 44 in this manner are subsequently transmitted to the control device 50 of the piece of furniture 10 (see FIGS. 2 and 3). The control device 50 comprises a command recognition module 52, a command conversion module 54, and a memory 56. The command recognition module 52 is adapted to check command patterns initiated by the user B which were detected using the command pattern detection units 36, 40, 42, 44 for correspondence with predefined command patterns stored in memory 56. Each of the command patterns stored in memory 56 is thereby representative of an actuation mode of an actuator Aᵢ of the piece of furniture 10. If a correspondence between a command pattern initiated by the user B and a predefined command pattern from memory 56 is determined to exist by the command recognition module 52, the corresponding command pattern is transmitted to the command conversion module 54 which converts the command pattern into a corresponding control command for controlling the respective actuator Aᵢ.

If, for example, the user B initiates or speaks the voice command pattern “headrest back”, this command pattern is detected by the microphone 36 and is checked by the command recognition module 52 for correspondence with a predefined command pattern from memory 56. If a correspondence is detected, the voice command pattern “headrest back” is thereupon converted by the command conversion module 54 into a corresponding control command that is then transmitted to the actuator Aᵢ to adjust the headrest.

So that no command patterns unconsciously initiated by the user B can be detected via the command pattern detection units 36, 40, 42, 44, a predefined start command can furthermore be stored in memory 56 that can be compared with a start command initiated by the user. The command pattern conversion of the command conversion module 54 is thereby only activated when the start command initiated by the user B corresponds to the predefined start command from memory 56. For example, the predefined start command can correspond to the voice pattern “Hi Molla” so that the command pattern conversion is only activated by the command conversion module 54 when the user correctly speaks or initiates the voice command “Hi Molla” as a start command.

As can be seen from FIG. 1, the piece of furniture 10 in accordance with the present invention can also comprise a rechargeable battery 58 for supplying the electrical consumers of the piece of furniture 10, such as the actuators or the control device 50, with electrical energy. In the shown embodiment, the battery 58 is integrated into the base 32 of the piece of furniture 10, with the battery 58 also being able to be accommodated in another component of the piece of furniture 10. Such a battery 58 can, for example, also be integrated into the back part 26 in some cases so that the battery 58 can be pushed from the rear into a corresponding receiver in the back part 26, with the battery 58 being freely accessible from the outside in the inserted state and being visible as a design feature.

In the shown embodiment, a loudspeaker 60 is also integrated into the headrest 24 so that the piece of furniture 10 or the control device 50 can communicate with the user B via the loudspeaker 60. The control device 50 can, for example, advise the user B via the loudspeaker 60 when a command pattern initiated by the user B was not able to be recognized by the command recognition module 52 so that the user B knows that he/she must again initiate the command pattern in question.

As can also be seen from FIG. 1 in conjunction with FIG. 2, the piece of furniture 10 can also comprise a processing unit 62 and a communication unit 64. The processing unit 62 is thereby adapted to convert commands input by a user into control commands for controlling one of the infrastructure devices 14, 16, 18, 20, whereas the communication unit 64, which can, for example, be a WLAN adapter, serves to transmit the control command to control one of the infrastructure devices 14, 16, 18, 20 via the router 22 to the respective infrastructure device 14, 16, 18, 20.

Corresponding commands could admittedly be input by the user B via a conventional input unit, such as a wired remote control; provision is, however, made in accordance with the present invention to use control device 50 with the command recognition module 52 and the command conversion module 54 for command pattern processing. The user B can thus control the infrastructure devices 14, 16, 18, 20 by voice commands, gesture commands, and/or tactile command sequences, for which purpose corresponding predefined command patterns are in turn stored in memory 56 of which each one is representative of an operating mode or an actuation mode of one of the infrastructure devices 14, 16, 18, 20. If, after input of a corresponding command pattern by user B, such as a gesture command, the command recognition module 52 detects that the input gesture pattern coincides with a predefined gesture pattern, the gesture pattern is converted by the command conversion module 54 into a corresponding control command to control the infrastructure device 14, 16, 18, 20. A control command thereby generated to control one of the infrastructure devices 14, 16, 18, 20 is then further processed by the processing unit 62 for outputting by the communication unit 64 so that the communication unit 64 can transmit the processed control command via the router 22 to the respective infrastructure device 14, 16, 18, 20 for controlling thereof.

The piece of furniture 10 thus serves as a control center for the infrastructure devices 14, 16, 18, 20 controllable by it since the user B can control the individual infrastructure devices 14, 16, 18, 20 via the functions of the piece of furniture 10 that are anyway present.

FIG. 2 shows that the control device 50 additionally communicates with a diagnostic module 66 via which a functional diagnosis of the piece of furniture 10 can be carried out. Such a functional diagnosis can, for example, be triggered by the user B in that he/she initiates a start command pattern for carrying out the functional diagnosis. The user B can, for example, trigger a functional diagnosis with the voice command pattern “functional diagnosis”, for which purpose the start command pattern must be recognized by the command recognition module 52, i.e., must be recognized as corresponding to a predefined start command pattern. If such a correspondence with a predefined start command pattern is recognized, the command conversion module 54 can subsequently convert the start command pattern into a start command to start the functional diagnosis, whereupon the functional diagnosis is carried out.

The functional diagnostic module 66 can also have a function via which a measure can be determined which is suitable based on the diagnosis result D of the functional diagnosis. Additionally or alternatively thereto, the diagnosis result D of the functional diagnosis can be transmitted via the communication unit 64 over the internet I to a remote entity E, such as to a service center of the manufacturer of the piece of furniture 10, which thereupon in turn determines a measure by which the diagnosis result D of the functional diagnosis can be taken into account. This measure can then in turn be transmitted over the internet I and the communication unit 64 to the piece of furniture 10 and can be brought to the attention of the user B, for example, via the loudspeaker 60, so that the user B can carry out corresponding measures.

The present invention is not limited to embodiments described herein; reference should be had to the appended claims.

### LIST OF REFERENCE NUMERALS

10 seating/reclining furniture/piece of furniture
12 living room
14 lamp
16 air-conditioning unit
18 entertainment unit
20 electric blind
22 router
24 headrest/component
26 back part/component
28 seat part/component
30 footrest/component
32 base
34 armrest/component
36 microphone/command pattern detection unit
38 operating unit/smartphone
40 camera/command pattern detection unit
42 touch unit/command pattern detection unit
44 pressure-sensitive sensor/command pattern detection unit
50 control device
52 command recognition module
54 command conversion module
56 memory
58 rechargeable battery
60 loudspeaker
62 processing unit
64 communication unit
66 diagnostic module
Aᵢ actuators
E entity/service center
I internet
B user
D diagnosis result

What is claimed is:

1. A seating/reclining furniture comprising:
at least one component selected from a seat part, a back part, a headrest, a footrest, and an armrest;
at least one actuator, each of the at least one actuator being configured to manipulate one of the at least one component; and
a control device configured to control the at least one actuator, the control device comprising,
a command recognition module configured to check at least one command pattern initiated by a user for a correspondence with at least one predefined command pattern which is representative of an actuation mode of the at least one actuator, and
a command conversion module configured to convert the command pattern into a control command for controlling the at least one actuator based on the correspondence of the at least one command pattern to the at least one predefined command pattern.

2. The seating/reclining furniture as recited in claim 1, wherein, the at least one command pattern initiated by the user includes at least one of a voice command, a gesture command, and a tactile command sequence.

3. The seating/reclining furniture as recited in claim 2, further comprising:
at least one microphone configured to detect the voice command initiated by the user, the at least one microphone being provided,
so as to be integrated into the seating/reclining furniture, or
as a component of a separate operating unit which communicates via a wireless communication with the control device.

4. The seating/reclining furniture as recited in claim 3, further comprising at least one of:
a camera integrated into at least one of the back part and the headrest, the camera being configured to detect the gesture command initiated by the user, and
a touch unit configured to detect the gesture command initiated by the user, the touch unit either being integrated into the seating/reclining furniture or being provided as a component of the separate operating unit which communicates via the wireless communication with the control device.

5. The seating/reclining furniture as recited in claim 4, wherein, for the detection of the tactile command sequence initiated by the user, the seating/reclining furniture further comprises:
at least one pressure-sensitive sensor that is integrated into at least one of the seat part, the back part, and the headrest.

6. The seating/reclining furniture as recited in claim 5, wherein the command recognition module is further configured to compare a predefined start command with a start command initiated by the user which is input via at least one command pattern detection unit which is selected from the at least one microphone, the camera, the touch unit, and the at least one pressure-sensitive sensor, the command recognition module comprising a command pattern conversion which is configured to only be activated when the start command initiated by the user corresponds to the predefined start command.

7. The seating/reclining furniture as recited in claim 1, further comprising:
a rechargeable battery configured to supply at least one electrical consumer with electrical energy,
wherein, the at least one electrical consumer includes at least one of the at least one actuator and the control device.

8. The seating/reclining furniture as recited in claim 1, further comprising:
at least one of a loudspeaker and a display device, each of which is configured so that the seating/reclining furniture communicates with the user.

9. A seating/reclining furniture comprising:
an input unit configured to input a command, each command representing an operating mode or an actuation mode of at least one an infrastructure device;
a processing unit configured to convert the command which is input into the input unit into a control command so as to control the at least one infrastructure device; and
a communication unit configured to provide a wireless communication with the internet and to transmit at least one control command to the at least one infrastructure device for the control thereof.

10. The seating/reclining furniture as recited in claim 9, wherein,
each command is a command pattern initiated by a user, and
the input unit comprises a control device which comprises,
a command recognition module configured to check a command pattern provided by the user for correspondence with predefined command patterns, each of the predefined command patterns representing an actuation mode of the at least one infrastructure device, and
a command conversion module configured to convert the command pattern into a control command to control the at least one infrastructure device based on a correspondence with the predefined command pattern.

11. The seating/reclining furniture as recited in claim 10, further comprising:
a diagnostic module configured to carry out a functional diagnosis of the seating/reclining furniture.

12. The seating/reclining furniture as recited in claim 11, wherein the diagnostic module is further configured to start the functional diagnosis at least one of by itself and upon receiving the command from the user.

13. The seating/reclining furniture as recited in claim 12, wherein
the command recognition module is further configured to check the command pattern initiated by the user for correspondence with the predefined command pattern which is representative of the start of the functional diagnosis, and
the command conversion module is further configured to convert the command pattern into a start command for starting the functional diagnosis based on a correspondence with the command pattern.

14. The seating/reclining furniture as recited in claim 11, wherein the diagnostic module is further configured to determine a measure which takes into account a diagnosis result of the functional diagnosis, to transmit the diagnosis result of the functional diagnosis via the communication unit to a remote entity that determines a measure which takes into account the diagnosis result of the functional diagnosis, and to receive the measure determined by the remote entity via the communication unit.

15. The seating/reclining furniture comprising:
at least one component selected from a seat part, a back part, a headrest, a footrest, and an armrest;
at least one actuator, each of the at least one actuator being configured to manipulate one of the at least one component;
a control device configured to control the at least one actuator, the control device comprising,
a command recognition module configured to check at least one command pattern initiated by a user for a correspondence with at least one predefined command pattern which is representative of an actuation mode of the at least one actuator, and
a command conversion module configured to convert the command pattern into a control command for controlling the at least one actuator based on the correspondence of the at least one command pattern to the at least one predefined command pattern;
an input unit configured to input a command, each command representing an operating mode or an actuation mode of at least one an infrastructure device;
a processing unit configured to convert the command which is input into the input unit into a control command so as to control the at least one infrastructure device; and
a communication unit configured to provide a wireless communication with the internet and to transmit at least one control command to the at least one infrastructure device for the control thereof.

16. The seating/reclining furniture as recited in claim 3, wherein,
the at least one microphone is integrated into the at least one component of the seating/reclining furniture so as to be manipulatable by the at least one actuator,
the component of the separate operating unit which communicates via the wireless communication with the control device is a smartphone, and
the wireless communication is provided via at least one of Bluetooth and infrared.

17. The seating/reclining furniture as recited in claim 4, wherein,
the touch unit is integrated into the armrest, or
the component of the separate operating unit which communicates via the wireless communication with the control device is a smartphone with the wireless communication being provided via at least one of Bluetooth and infrared.

18. The seating/reclining furniture as recited in claim 6, wherein the predefined start command corresponds to a voice pattern “Hi Molla”.
